(19) United States
(12) Patent Application Publication
(10) Pub. No.: US 2007/0262757 A1
(43) Pub. Date: Nov. 15, 2007

(54) POWER SUPPLY APPARATUS CAPABLE OF DECREASING RIPPLE COMPONENT AND DISPLAY APPARATUS USING THE SAME

(75) Inventor: Hirokazu Kawagoshi, Ohtsu-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/745,641

(22) Filed: May 8, 2007

(30) Foreign Application Priority Data
May 9, 2006 (JP) 2006-130196

(51) Int. Cl. G05F 1/00

(52) U.S. Cl. 323/265

(57) ABSTRACT

In a power supply apparatus including a step-up circuit, an output terminal is provided and connectable to an external smoothing circuit formed by a parasitic resistance of a connection layer and an external capacitor. A resistor is connected between an output end of the step-up circuit and the output terminal.

### BACKGROUND OF THE INVENTION

1. Field of the Invention

The present invention relates to a power supply apparatus capable of decreasing a ripple component and a display apparatus using such a power supply apparatus.

2. Description of the Related Art

Display apparatuses such as liquid crystal display (LCD) apparatuses have been broadly used in personal computers, television sets, mobile phones or personal digital assistants (PDAs). In such a display apparatus, a power supply apparatus supplies power supply voltages to a controller, data line (or signal line) drivers, scan line (or gate line) drivers and an LCD panel.

On the other hand, in order to decrease the manufacturing costs and the size and increase the LCD panel in size, the mounting technology has been changed from the tape carrier package (TCP) technology to the chip on glass (COG) technology.

A prior art power supply apparatus is formed as one semiconductor device (chip) is formed on a glass substrate of a COG package on which other semiconductor devices (chips) such as a controller, data line (or signal line) drivers or scan line (or gate line) drivers as well as an LCD panel are also formed.

This power supply apparatus is constructed by a charge-pump type step-up circuit and a regulator (see: FIG. 16 of JP-2004-157580A).

The charge-pump type step-up circuit is connected to an output terminal (pad) which is also connected to an external smoothing circuit formed by a parasitic resistance of a wiring (connection) layer made of indium tin oxide (ITO) and an external capacitor, thus removing a part of a ripple component (noise) in the output voltage of the charge-pump type step-up circuit.

On the other hand, the regulator is constructed by an operational amplifier powered by the output voltage of the charge-pump type step-up circuit. The operational amplifier is connected to another output terminal (pad) which is also connected to another external smoothing circuit formed by a parasitic resistance of a connection layer made of ITO and an external capacitor, thus removing a part of a ripple component (noise) in the output voltage at the other output pad. The ripple component of the output voltage of the charge-pump type step-up circuit applied as a power voltage to the operational amplifier can be decreased by the ripple reducing effect of the operational amplifier per se, and can be further decreased by the external smoothing circuit.

This prior art power supply apparatus will be explained later in detail.

### SUMMARY OF THE INVENTION

In the above-described prior art power supply apparatus, however, the reduction of the ripple component of the output voltage of the charge-pump type step-up circuit is carried out by only the external smoothing circuit, and the reduction of the ripple component of the output voltage of the operational amplifier is carried out by only the operational amplifier and the other external smoothing circuit, so that the reduction of the ripple components is insufficient.

According to the present invention, in a power supply apparatus including a step-up circuit, an output terminal is provided and connectable to an external smoothing circuit formed by a parasitic resistance of a connection layer and an external capacitor. A resistor is connected between an output end of the step-up circuit and the output terminal.

Thus, the ripple component of the output voltage of the step-up circuit can be decreased by the resistor as well as the external smoothing circuit.

Also, there is provided a display apparatus comprising: an indium tin oxide connection layer; a smoothing capacitor connected to a first end of the indium tin oxide connection layer; a metal connection layer having a first end connected to a second end of the indium tin oxide connection layer; an amplifier connected to a second end of the metal connection layer; a step-up circuit adapted to generate a step-up voltage at its output end; and a resistor connected between the output end of the step-up circuit and a predetermined node of the metal connection layer.

### BRIEF DESCRIPTION OF THE DRAWINGS

The present invention will be more clearly understood from the description set forth below, as compared with the prior art, with reference to the accompanying drawings, wherein:

FIG. 1 is a circuit diagram illustrating a prior art power supply apparatus;

FIG. 2 is a detailed circuit diagram of the charge-pump type step-up circuit of FIG. 1;

FIG. 3 is a timing diagram for explaining the operation of the power supply apparatus of FIG. 1;

FIG. 4 is a circuit diagram illustrating a first embodiment of the power supply apparatus according to the present invention;

FIG. 5 is a timing diagram for explaining the operation of the power supply apparatus of FIG. 4;

FIG. 6 is a circuit diagram illustrating a first modification of the power supply apparatus of FIG. 4;

FIG. 7 is a circuit diagram illustrating a second modification of the power supply apparatus of FIG. 4;

FIG. 8 is a circuit diagram illustrating a second embodiment of the power supply apparatus according to the present invention; and

FIG. 9 is a detailed circuit diagram of the regulator of FIG. 8.

### DESCRIPTION OF THE PREFERRED EMBODIMENTS

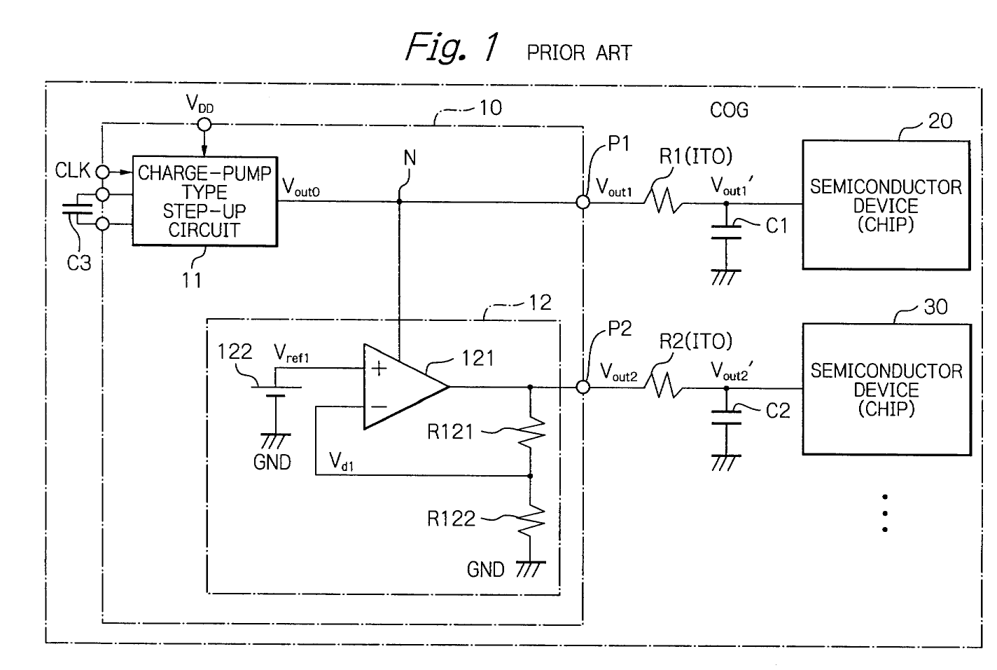

Before the description of the preferred embodiments, a prior art power supply apparatus will be explained with reference to FIGS. 1, 2 and 3.

In FIG. 1, which illustrates a prior art power supply apparatus, a power supply apparatus 10 formed as one semiconductor device (chip) is formed on a glass substrate (not shown) on which other semiconductor devices (chips) 20 and 30 such as a controller, data line (or signal line) drivers or scan line (or gate line) drivers as well as an LCD panel (not shown) are also formed. Thus, one liquid crystal display (LCD) apparatus is formed by a chip on glass (COG) technology.

The power supply apparatus 10 is constructed by a charge-pump type step-up circuit 11 and a regulator 12 (see: FIG. 16 of JP-2004-157580A).

The charge-pump type step-up circuit 11 is connected to an output terminal (pad) P1 which is also connected to a smoothing circuit formed by a parasitic resistance R1 of a connection layer made of ITO and an external capacitor C1, thus removing a part of a ripple component (noise) r0 in the output voltage Vₒᵤₜ₀ of the charge-pump type step-up circuit 11, i.e., in the output voltage Vₒᵤₜ₁ at the output terminal P1. The output voltage Vₒᵤₜ₁ is supplied from the output pad P1 via the parasitic resistance R1 to the semiconductor chip 20. In this case, the parasitic resistance R1 is connected between the output pad P1 and the semiconductor chip 20.

The regulator 12 is constructed by an operational amplifier 121 powered by the output voltage Vₒᵤₜ₀ of the charge-pump type step-up circuit 11 via a node N of a metal layer. The operational amplifier 121 has a positive input receiving a reference voltage V_{ref1} generated by a reference voltage regulator 122 such as a band-gap regulator and a negative input to which an output voltage Vₒᵤₜ₂ is negatively fed back via a resistor R121. Also, the negative input is connected via a resistor R122 to the ground terminal GND. Thus, since the resistors R121 and R122 form a voltage divider for generating a divided voltage V_{d1}

V_{d1}=Vₒᵤₜ₂·R122/(R121+R122)

the output voltage Vₒᵤₜ₂ is obtained by

Vₒᵤₜ₂=((R121+R122)/R122)·V_{ref1}

where R121 and R122 also designate resistance values of the resistors R121 and R122, respectively.

Note that the band-gap regulator is constructed by one or more pn junction elements for generating a definite voltage such as about 1.2V or a multiple of about 1.2V regardless of the temperature and the power supply voltage applied thereto.

The regulator 12 is connected to an output terminal (pad) P2 which is also connected to an external smoothing circuit formed by a parasitic resistance R2 of a connection layer made of ITO and an external capacitor C2, thus removing a part of a ripple component (noise) r2 in the output voltage Vₒᵤₜ₂ at the output pad P2. The output voltage Vₒᵤₜ₂ is supplied from the output pad P2 via the parasitic resistance R2 to the semiconductor chip 30. In this case, the parasitic resistance R2 is connected between the output pad P2 and the semiconductor chip 30.

The charge-pump type step-up circuit 11 is connected to an external step-up capacitor C3. The charge-pump type step-up circuit receives a power supply voltage V_{DD} such as about 2.7V to generate the output voltage 2·V_{DD} such as about 5.4V in response to a clock signal CLK.

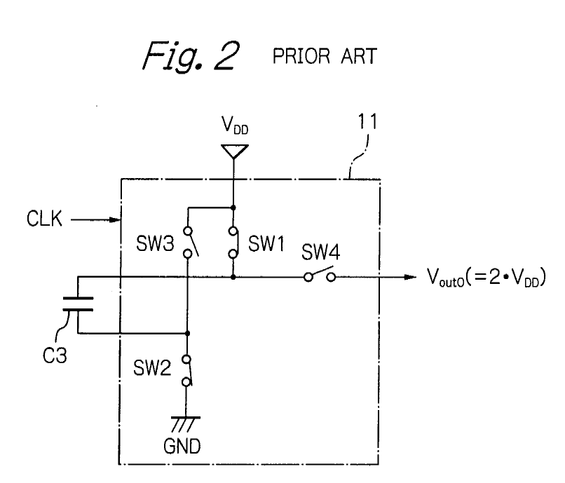

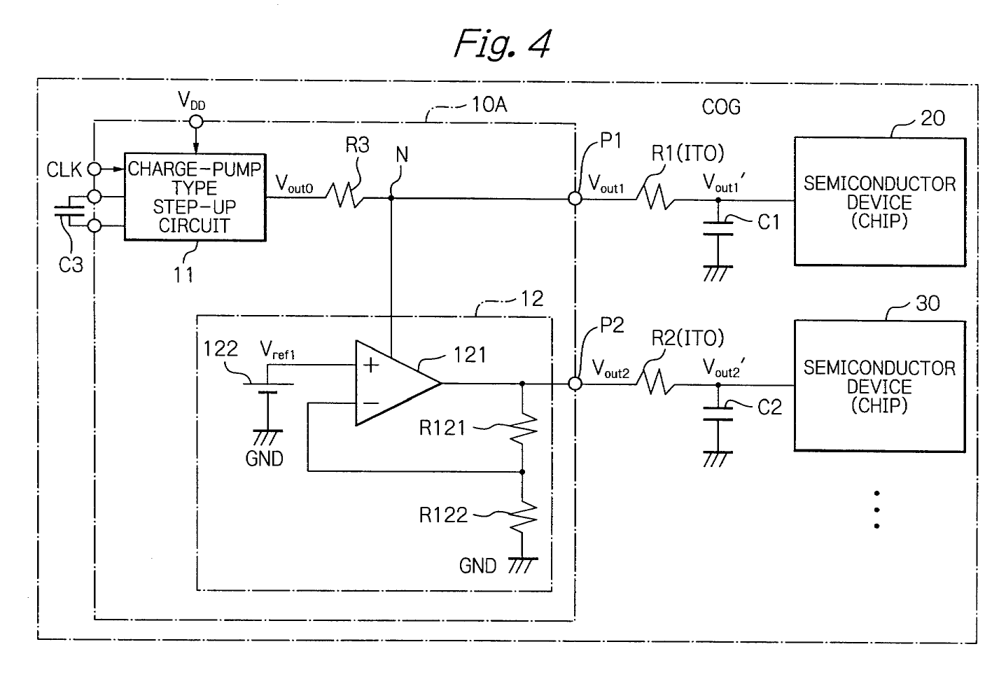

As illustrated in FIG. 2 (see: FIG. 4 of JP-2005-20971A), the charge-pump type step-up circuit 11 is constructed by four switches SW1, SW2, SW3 and SW4. In this case, the set of the switches SW1 and SW2 as charging switching elements and the set of the switches SW3 and SW4 as discharging switching elements are complementarily turned ON and OFF by the clock signal CLK. That is, in a stand-by state where CLK=“0” (low level), the switches SW1 and SW2 are turned ON while the switches SW3 and SW4 are turned OFF, so that the step-up capacitor C3 is charged by the power supply voltage V_{DD}. On the other hand, in a step-up state where CLK=“1” (high level), the switches SW1 and SW2 are turned OFF while the switches SW3 and SW4 are turned ON, so that the power supply voltage V_{DD} is superposed onto the charged voltage of the step-up capacitor C3. Thus, the stand-by state and the step-up state are alternately repeated, so that a voltage at the smoothing capacitor C1 of FIG. 1, i.e., the output voltage Vₒᵤₜ₀ becomes higher than the power supply voltage V_{DD}. In this case, if duration periods of the stand-by state and the step-up state are long enough to charge the step-up capacitor C3 and the smoothing capacitor C1, respectively, at their saturation states, the output voltage Vₒᵤₜ₀ of the charge-pump type step-up circuit 11 would become a voltage of 2·V_{DD}.

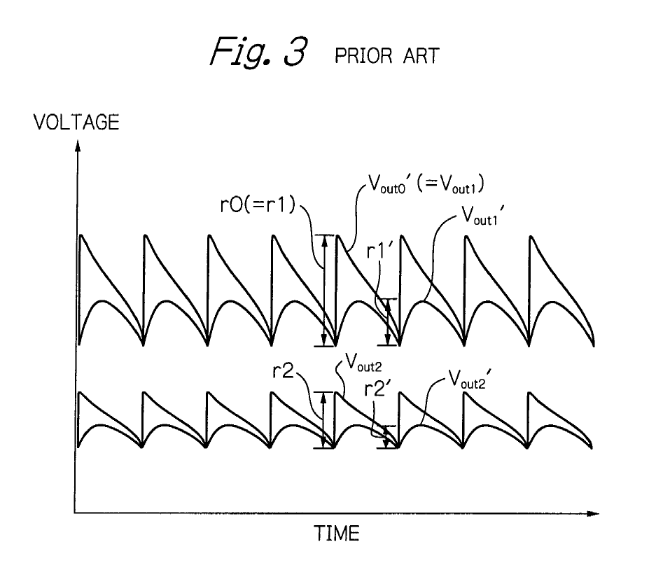

Thus, as illustrated in FIG. 3, in the power supply apparatus 10 of FIG. 1, the ripple component r0 of the output voltage Vₒᵤₜ₀ can be decreased by the smoothing circuit (R1, C1) to the ripple component r1′ of the output voltage Vₒᵤₜ₁′. That is, since the parasitic resistance R1 is made of ITO which has a larger resistivity than metal, the ripple component r0 of the output voltage Vₒᵤₜ₀ is enhanced by the increased resistance of ITO. Also, the ripple component r0 of the output voltage Vₒᵤₜ₀ applied as a power voltage to the operational amplifier 121 can be decreased by the ripple reducing effect of the operational amplifier 121 per se to the ripple component r2 of the output voltage Vₒᵤₜ₂, and the ripple component r2 of the output voltage Vₒᵤₜ₂ can be further decreased by the smoothing circuit (R2, C2) to the ripple component r2′ of the output voltage Vₒᵤₜ₂.

In an LCD apparatus, as LCD panels have become increased in size and a high resolution has been required, the power supply apparatus 10 of FIG. 1 needs to be not only lower in power but also accurate. In the power supply apparatus 10 of FIG. 1, however, the reduction of the ripple component r1′ of the output voltage Vₒᵤₜ₁′ is carried out by only the smoothing circuit (R1, C1), and the reduction of the ripple component r2′ of the output voltage Vₒᵤₜ₂′ is carried out by only the operational amplifier 121 and the smoothing circuit (R2, C2), so that the reduction of the ripple components r1′ and r2′ is insufficient.

In order to further suppress the ripple component r2′ of the output voltage Vₒᵤₜ₂′ to realize an LCD apparatus with less flicker, the ripple reducing effect of the operational amplifier 121 may be increased. In this case, the operational amplifier 121 becomes large in size so that the power supply apparatus 10 of FIG. 1 becomes large in size. Thus, the reduction in size by the COG technology has a trade-off relationship with the accuracy of the power supply apparatus 10 of FIG. 1.

Additionally, when another regulator is added to the charge-pump type step-up circuit 11 to realize a pulse skip type step-up circuit, the frequency of the output voltage Vₒᵤₜ₀ of the charge-pump type step-up circuit 10 fluctuates due to the fluctuation of the power supply voltage V_{DD} and the fluctuation of loads of the semiconductor devices (chips) 20, 30 and the like, so that the frequency of the output voltage Vₒᵤₜ₀ of the charge-pump type step-up circuit 11 falls in a ripple reduction range of the frequency of the operational amplifier 121. Thus, the ripple reducing effect of the operational amplifier 121 would deteriorate, so that the LCD apparatus would exhibit a display abnormality.

In FIG. 4, which illustrates a first embodiment of the power supply apparatus according to the present invention, the power supply apparatus 10 of FIG. 1 is replaced by a power supply apparatus 10A where a resistor R3 is connected between an output end of the charge-pump type step-up circuit 11 and the node N of FIG. 1. The resistor R3 is formed by polycrystalline silicon, an impurity diffusion region, a well region, an impurity diffusion region formed in a well region and the like which are manufactured by semiconductor manufacturing steps. The resistance value of the resistor R3 is determined in view of the resistance value of the resistor R1. For example, if the resistance value of the parasitic resistance R1 is 50 Ω, the resistance value of the resistor R3 is 50 Ω, so that the ripple component r1 of the output voltage Vₒᵤₜ₁ can be halved as compared with the ripple component r0 of the output voltage Vₒᵤₜ₀ of the charge-pump type step-up circuit 10.

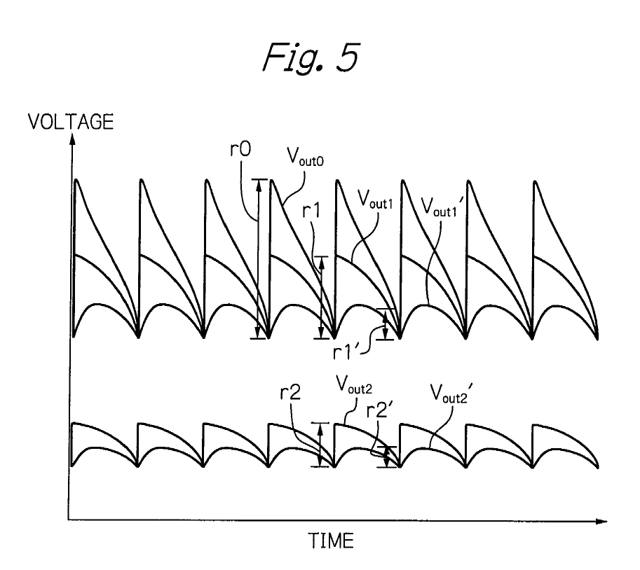

Thus, as illustrated in FIG. 5, in the power supply apparatus 10A of FIG. 4, the ripple component r0 of the output voltage Vₒᵤₜ₀ can be decreased by the resistor R3 to the ripple component r1 of the output voltage Vₒᵤₜ₁, and the ripple component r1 of the output voltage Vₒᵤₜ₁ can be decreased by the smoothing circuit (R1, C1) to the ripple component r1′ of the output voltage Vₒᵤₜ₁′. In this case, since the resistor R3 is introduced and the measuring condition is different, the ripple component r0 of the output voltage Vₒᵤₜ₀ of FIG. 5 is larger than the ripple component r0 of the output voltage Vₒᵤₜ₀ of FIG. 3. However, the ripple component r1 of the output voltage Vₒᵤₜ₁ of FIG. 5 is decreased by a voltage division effect of the resistor R3 to half of the ripple component r0 of the output voltage Vₒᵤₜ₀. Also, the ripple component r1 of the output voltage Vₒᵤₜ₁ applied as a power voltage to the operational amplifier 121 can be decreased by the ripple reducing effect of the operational amplifier 121 per se to the ripple component r2 of the output voltage Vₒᵤₜ₂, and the ripple component r2 of the output voltage Vₒᵤₜ₂ can be further decreased by the smoothing circuit (R2, C2) to the ripple component r2′ of the output voltage Vₒᵤₜ₂′.

In the power supply apparatus 10A of FIG. 4, the reduction of the ripple component r1′ of the output voltage Vₒᵤₜ₁′ is carried out by the resistor R3 as well as the smoothing circuit (R1, C1), and the reduction of the ripple component r2′ of the output voltage Vₒᵤₜ₂′ is carried out by the resistor R3 as well as the operational amplifier 121 and the smoothing circuit (R2, C2), so that the reduction of the ripple components r1′ and r2′ is sufficient.

In the power supply apparatus 10A of FIG. 5, although the output resistance value of the charge-pump type step-up circuit 11 is increased by the resistor R3, the output resistance value of the charge-pump type step-up circuit 11 is increased by the parasitic resistance R1 of a connection layer of the smoothing capacitor C1 and a connection layer for receiving the power supply voltage V_{DD}. Therefore, the ability of the charge-pump type step-up circuit 11 is not so decreased.

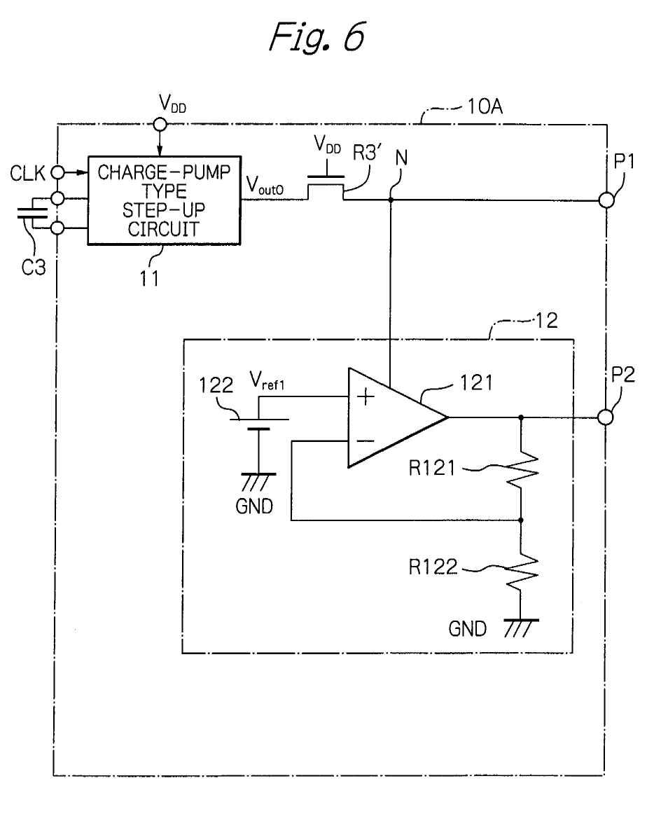

In FIG. 6, which illustrates a first modification of the power supply apparatus 10A of FIG. 4, the resistor R3 is replaced by an ON-state transistor R3′ such as an ON-state MOS transistor or an ON-state bipolar transistor. Thus, the additional resistor R3 is unnecessary.

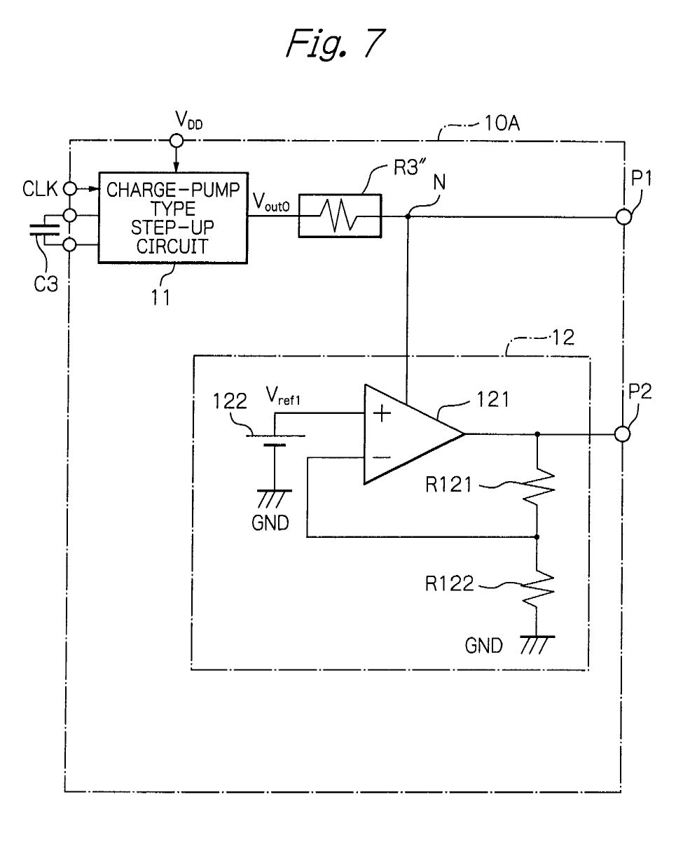

In FIG. 7, which illustrates a second modification of the power supply apparatus 10A of FIG. 4, the resistor R3 is replaced by a connection (or wiring) resistance R3″. Thus, the additional resistor R3 is unnecessary.

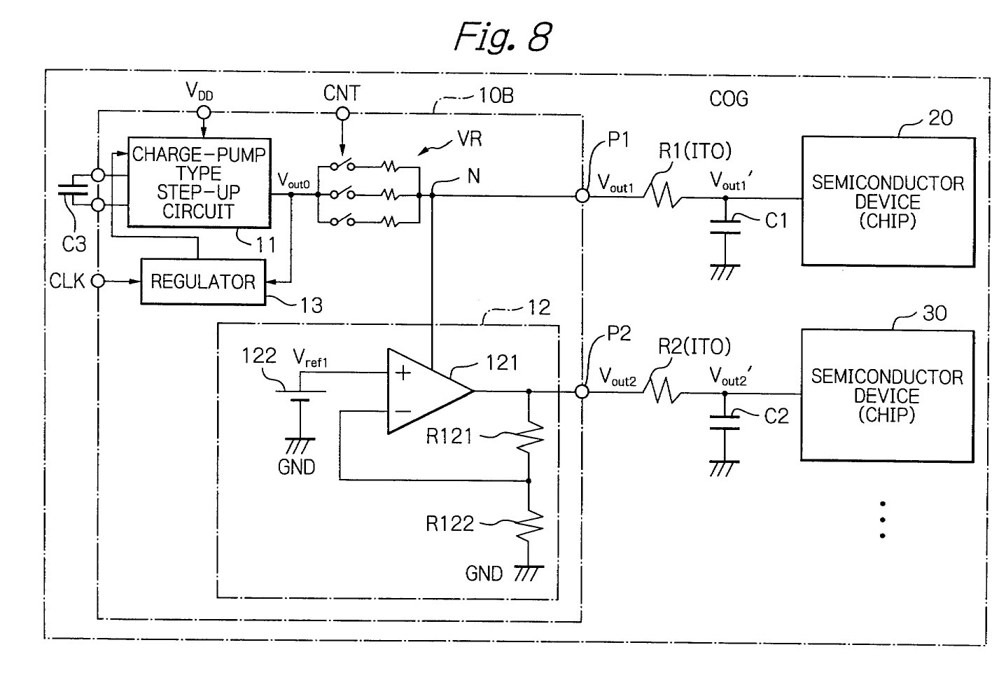

In FIG. 8, which illustrates a second embodiment of the power supply apparatus according to the present invention, the power supply apparatus 10A of FIG. 4 is replaced by a power supply apparatus 10B where the resistor R3 of FIG. 4 is replaced by a variable resistor VR which is constructed by a plurality of resistors and switches controlled by external control signal CNT, and a regulator 13 is added to the elements of the power supply apparatus 10A. Thus, the charge-pump type step-up circuit 11 and the regulator 13 are combined into a pulse skip type step-up circuit.

In the power supply apparatus 10B of FIG. 8, when the output voltage Vₒᵤₜ₀ of the charge-pump type step-up circuit 11 exceeds a predetermined value, the regulator 13 stops the generation of the clock signal CLK, so that the operation of the charge-pump type step-up circuit 11 is stopped. In this case, the variable resistor VR is adjusted so that the operation frequency of the charge-pump type step-up circuit 11 does not fall in a frequency range of the operational amplifier 121 which would deteriorate the ripple removing effect.

In the charge-pump type step-up circuit 11, if the duration period of the stand-by state and the step-up state is insufficient to charge the step-up capacitor C3 and the smoothing capacitor C1, respectively, at their non-saturation states, the output voltage Vₒᵤₜ₀ of the charge-pump type step-up circuit 11 would become smaller than 2·V_{DD}. That is, the regulator 13 is provided to make the output voltage Vₒᵤₜ₀ of the charge-pump type step-up circuit 11 to be a target voltage Vₜ which satisfies the following:

Vₜ≦2·V_{DD}

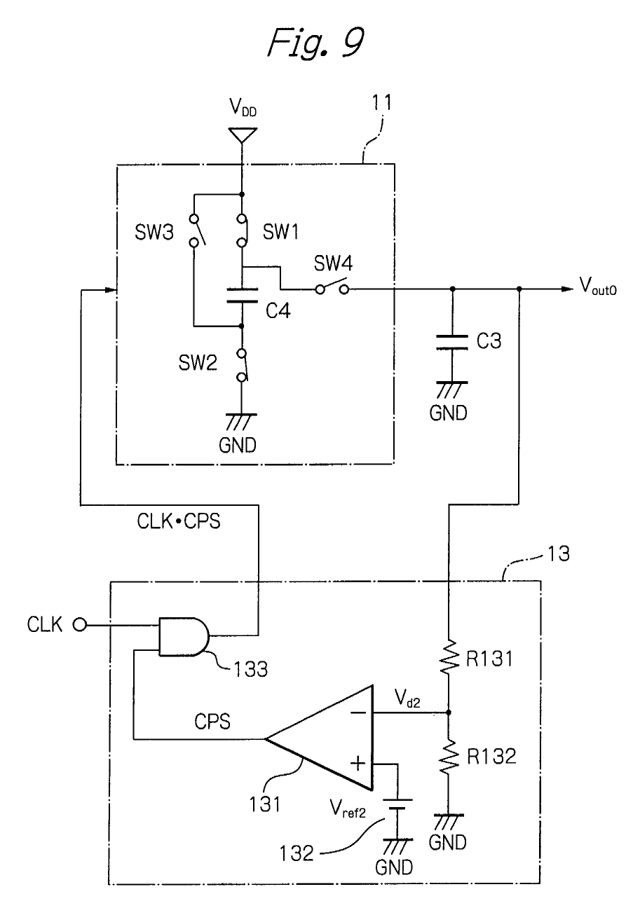

In FIG. 9, which is a detailed circuit diagram of the regulator 13 of FIG. 8, the regulator 13 is constructed by a voltage divider formed by resistors R131 and R132 for generating a divided voltage V_{d2} of the output voltage Vₒᵤₜ₀ of the charge-pump type step-up circuit 11, a reference voltage source 132 formed by a band gap regulator or the like for generating a reference voltage V_{ref2} corresponding to the target voltage Vₜ, a comparator 131 for comparing the divided voltage V_{d2} of the voltage divider with the reference voltage V_{ref2} to generate a comparison output signal CPS, and an AND circuit 133 for passing a clock signal CLK therethrough as the clock signal CLK·CPS in accordance with the comparison output signal CPS.

Also, the divided voltage V_{d2} is represented by

V_{d1}=Vₒᵤₜ₀·R132/(R131+R132)

where R131 and R132 designate the resistance values of the resistors R131 and R132, respectively.

Therefore, the regulator 13 regulates the output voltage Vₒᵤₜ₀ of the charge-pump type step-up circuit 11 so that the output voltage Vₒᵤₜ₀ is brought close to the target voltage Vₜ represented by

Vₜ=V_{ref2}·(R131+R132)/R132≦2·V_{DD}

Thus, the target voltage Vₜ can be set by adjusting one or more of the reference voltage V_{ref2} and the resistors R131 and R132.

In other words, the comparator 131 substantially compares the output voltage Vₒᵤₜ₀ of the charge-pump type step-up circuit 11 with the target voltage Vₜ, to generate the comparison output signal CPS. That is, if Vₒᵤₜ₀≦Vₜ, CPS=“1” (high level). On the other hand, if Vₒᵤₜ₀>Vₜ, CPS=“0” (low level).

In the power supply apparatus 10A of FIG. 4, note that the variable resistor VR of FIG. 8 can be used instead of the resistor R3. Also, in the power supply apparatus 10B of FIG. 8, note that the resistor R3, the ON-state transistor R3′ of the connection resistance R3″ of FIG. 4 can be used instead of the variable resistor VR.

Further, in the power supply apparatuses 10A and 10B of FIGS. 4 and 8, the output terminal (pad) P1 to be connected to the smoothing circuit (R1, C1) can be omitted.

1. A power supply apparatus comprising:
a step-up circuit;
a first output terminal connectable to a first external smoothing circuit formed by a first parasitic resistance of a first connection layer resistor and a first external capacitor; and
a resistor connected between an output end of said first step-up circuit and said first output terminal.

2. The power supply apparatus as set forth in claim 1, wherein said step-up circuit and said resistor are formed on one semiconductor device, and said first parasitic resistance and said first external capacitor are formed on a substrate of a display apparatus.

3. The power supply apparatus as set forth in claim 1, wherein said resistor comprises an ON-state transistor.

4. The power supply apparatus as set forth in claim 1, wherein said resistor comprises a connection resistance.

5. The power supply apparatus as set forth in claim 1, wherein said resistor comprises a variable resistor.

6. The power supply apparatus as set forth in claim 1, further comprising:
a second output terminal connectable to a second external smoothing circuit formed by a second parasitic resistance of a second connection layer and a second external capacitor; and
a first regulator including an operational amplifier powered by a voltage at said first output terminal, said operational amplifier having a ripple reducing effect and an output end connected to said second output terminal.

7. The power supply apparatus as set forth in claim 1, wherein said step-up circuit comprises a charge-pump type step-up circuit adapted to step up a power supply voltage in synchronization with a clock signal.

8. The power supply apparatus as set forth in claim 7, further comprising a second regulator adapted to compare an output voltage from said charge-pump type step-up circuit with a target voltage to generate said clock signal so that the output voltage of said charge-pump type step-up circuit is brought close to said target voltage.

9. A power supply apparatus comprising:
a step-up circuit;
a resistor having a first end connected to an output end of said step-up circuit;
an output terminal connectable to an external smoothing circuit formed by a parasitic resistance of a connection layer and an external capacitor; and
a first regulator including an operational amplifier powered by a voltage at a second end of said resistor, said operational amplifier having a ripple reducing effect and an output end connected to said output terminal.

10. The power supply apparatus as set forth in claim 9, wherein said step-up circuit and said resistor are formed on one semiconductor device, and said parasitic resistance and said external capacitor are formed on a substrate of a display apparatus.

11. The power supply apparatus as set forth in claim 9, wherein said resistor comprises an ON-state transistor.

12. The power supply apparatus as set forth in claim 9, wherein said resistor comprises a connection resistance.

13. The power supply apparatus as set forth in claim 9, wherein said resistor comprises a variable resistor.

14. The power supply apparatus as set forth in claim 9, wherein said step-up circuit comprises a charge-pump type step-up circuit adapted to step up a power supply voltage in synchronization with a clock signal.

15. The power supply apparatus as set forth in claim 14, further comprising a second regulator adapted to compare an output voltage from said charge-pump type step-up circuit with a target voltage to generate said clock signal so that the output voltage of said charge-pump type step-up circuit is brought close to said target voltage.

16. A power supply apparatus comprising:
a step-up circuit;
a node;
a circuit powered by a voltage at said node;
an output pad connected to said node and capable of being connected to an external smoothing capacitor; and
a resistor connected between an output end of said step-up circuit and said node.

17. A display apparatus comprising:
an indium tin oxide connection layer;
a smoothing capacitor connected to a first end of said indium tin oxide connection layer;
a metal connection layer having a first end connected to a second end of said indium tin oxide connection layer;
an amplifier connected to a second end of said metal connection layer;
a step-up circuit adapted to generate a step-up voltage at its output end; and
a resistor connected between the output end of said step-up circuit and a predetermined node of said metal connection layer.

18. The display apparatus as set forth in claim 17, further comprising:
another indium tin oxide connection layer having a first end connected to the output end of said amplifier; and
another smoothing capacitor connected to a second end of said other indium tin oxide connection layer.
